(19) United States
(12) Patent Application Publication
(10) Pub. No.: US 2018/0003851 A1
(43) Pub. Date: Jan. 4, 2018

(54) WIRELESS FLUIDIC READOUT PLATFORM FOR SENSORS

(71) Applicant: Trustees of Boston University, Boston, MA (US)

(72) Inventors: Xin Zhang, Medford, MA (US); Huseyin Rahmi Seren, Houston, TX (US); Xiaoguang Zhao, Boston, MA (US); Guangwu Duan, Boston, MA (US); Congshun Wang, Reading, MA (US); Caipeng Chen, Harrison, NJ (US)

(21) Appl. No.: 15/637,198

(22) Filed: Jun. 29, 2017

Related U.S. Application Data
(60) Provisional application No. 62/356,592, filed on Jun. 30, 2016.

(51) Int. Cl. G01V 3/26; G01V 3/34; G01F 1/74; G01V 3/38; E21B 47/01

(52) U.S. Cl. CPC G01V 3/26; G01V 3/38; E21B 47/01; G01F 1/74; G01V 3/34

(57) ABSTRACT

Near-field magnetic resonance is used to retrieve information stored in sensors passing through a fluidic channel in a fluidic medium, and can also be used for recharging a power source in the sensors. The sensors have been previously injected into a downhole and/or reservoir environment, and are then retrieved in order to access the information the sensors have obtained by measuring physical and/or chemical properties of the downhole and/or reservoir.

This application claims priority to U.S. provisional patent application Ser. No. 62/356,592, which is hereby incorporated by reference herein.

### TECHNICAL FIELD

The present disclosure relates in general to wireless sensor systems, and in particular, to a platform for wireless readout from, and charging of, sensors retrieved from a geological formation and/or a wellbore.

### BACKGROUND INFORMATION

In-situ measurement of the physical and chemical properties present in a downhole (e.g., a wellbore), geological and/or subterranean formation, and/or reservoir environment is very important for the oil and gas industry in order to increase the recovery rate and reduce production costs. Currently, there are two methods utilized for sure measurements. A first method is performed during the stage of wellbore drilling (i.e., logging while drilling) in which sensors are integrated onto the drilling bit and the logging wire. Thus, measurements of the physical and/or chemical properties present around the drilling bit and the logging wire (e.g., temperature, pressure, pH, position, etc.) are sent back to a control center at the surface for analysis during the drilling operations. A second method is performed during the producing stage of the wellbore (i.e., wireline logging). To perform such measurements, the producing process is usually halted, and a sensing cabin is sent downhole into the wellbore. This technique requires a several kilometers long wire, which further requires the use of a carrier truck, a winch, and an operation crew, which is expensive and time consuming to implement.

### SUMMARY

In this disclosure, for the sake of simplicity, the term “reservoir” will be utilized to refer to all geological and/or subterranean formations/environments. Furthermore, though embodiments of the present disclosure are described with respect to oil/gas production, embodiments of the present disclosure are applicable to the recovery of any hydrocarbon, water, or any other material from a geological formation, or simply the retrieval of physical and/or chemical properties present within any geological formation.

Aspects of the present disclosure provide a system for retrieving information from one or more sensors (which may be miniaturized (e.g., nano- or micron-sized) sensor packages that are low cost and can survive and measure and store specified information present (e.g., physical and/or chemical properties) in downhole (e.g., the drilling and/or production wellbores), subterranean, and reservoir (e.g., oil/gas) environments whenever desired by the field engineers, including without interrupting the production process. Moreover, such small sensors can be configured to reach into places that are only several hundreds of micrometers in size, such as reservoir fracture openings. Aspects of the present disclosure provide a technology platform configured to interrogate such sensors to retrieve such information and/or recharge their onboard power source (e.g., a battery). Due to the large losses for electromagnetic waves propagated in reservoir environments, the very large distances from the surface of a reservoir in which such sensors are injected, and the small size of the onboard sensor antenna, it is nearly impossible to communicate with and charge such sensors downhole and in the reservoir using the current state of technology. This problem is addressed by aspects of the present disclosure by physically retrieving the sensors back to the surface. Since the sensor antenna size limits the utilization of far-field communication and power transfer, and since large quantities of the sensors may be interrogated, aspects of the present disclosure utilize a high efficiency near-field based fluidic readout and/or recharging strategy, which is able to interrogate and recharge a plurality of retrieved sensors with a high throughput rate.

### BRIEF DESCRIPTION OF THE DRAWINGS

FIG. 1 illustrates a work cycle for utilization of a sensor (or sensors) for downhole and/or reservoir monitoring, in accordance with embodiments of the present disclosure.

FIG. 2 illustrates a magnetically coupled resonator as a reader antenna to work with sensors, in accordance with embodiments of the present disclosure.

FIG. 3 illustrates a portion of a sensor reader platform configured in accordance with embodiments of the present disclosure.

FIG. 4 illustrates an exploded view of the sensor reader platform illustrated in FIG. 3.

FIG. 5 illustrates a split ring reader antenna configured in accordance with embodiments of the present disclosure.

FIG. 6 shows the H-field strength in the z-direction (i.e., direction that is perpendicular to this paper) of the split ring reader antenna illustrated in FIG. 5.

FIG. 7 shows an image of exemplary embodiments of the present disclosure incorporating a coupling loop with arrays of spiral resonators.

FIG. 8 shows the H-field strength in the z-direction (i.e., direction that is perpendicular to this paper) of the embodiments illustrated in FIG. 7.

FIG. 9 illustrates an example of a local field enhancement package configured in accordance with embodiments of the present disclosure.

FIG. 10 illustrates a flowchart diagram of a process for filtering microsensors from an extracted fluid.

FIG. 11 illustrates a block diagram of exemplary reader and sensor circuits configured in accordance with embodiments of the present disclosure.

### DETAILED DESCRIPTION

Even though a long distance communication technique may be desired in order to perform real-time measurements within a downhole or reservoir environment, it is not feasible due to high losses in electromagnetic and acoustic wave propagations and such a small sensor size factor. Therefore, embodiments of the present disclosure utilize a short distance communication technique assuming that the measured information is stored in the sensor circuitry, and the sensors are then collected back from the downhole and/or reservoir environment for further analysis.

As such, embodiments of the present disclosure utilize near-field magnetic resonance as a way of communication, which is widely used in radio frequency identification (“RFID”) and near-field communication (“NFC”) systems. Additionally, near-field magnetic resonance is well-known for high efficiency wireless power transfer, and thus can be used for recharging a power source in the sensors. Moreover, integration of antennas into a fluidic channel enables a high efficiency platform for reading out (retrieving) information from and/or power source recharging of sensors that have been previously injected into the downhole and/or reservoir environment.

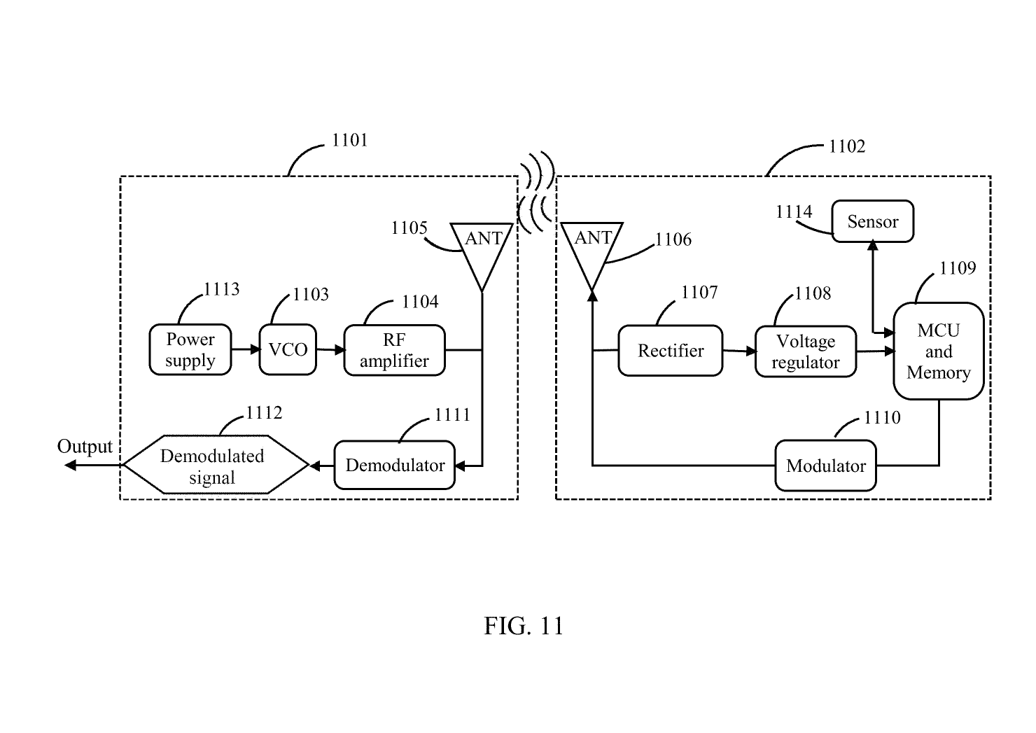

In order to increase oil and/or gas (or any type of hydrocarbon) production efficiencies, a better understanding of the variation in the physical and chemical environments of the downhole and/or reservoir environment are required. As previously noted in the Background Information section, current measurement methods are limited in their resolution, detection range, and the cost. However, if the deep downhole and/or reservoir conditions can be measured directly, then a fundamentally better understanding of the downhole and/or reservoir environment can be obtained. To realize this, embodiments of the present disclosure transport sensors into the downhole and/or reservoir environment (for example, to allow them to diffuse into the porous sandstone of typical reservoirs). The sensors are configured to then make measurements to map specified conditions (e.g., physical and/or chemical properties) within these environments. Subsequently, the sensors are retrieved back to the surface for interrogation. Because the feature size of such sensors is too small to retrieve the measured information directly through wires/cables, embodiments of the present disclosure utilize a wireless approach for the interrogation of the measured information stored within the sensors. The sensors utilized within embodiments of the present disclosure may include a sensing component, a power supply, a microprocessor/microcontroller and associated memory, and a sensor antenna (e.g., see FIG. 11). They may be programmed so that the microprocessor/microcontroller starts a measurement at a desired time and/or location, and stores the measured data in the downhole and/or reservoir environment. The sensors are then subsequently retrieved back to the surface where the collected sensors may be filtered and prepared for the data interrogation. Then, the stored measured information is retrieved from the sensors while inside a fluidic channel where the sensors may also be recharged and/or reprogrammed for the next mission after the information collection. The sensors carry an integrated sensor antenna, which is designed and configured to resonantly couple with a reader antenna, as described herein.

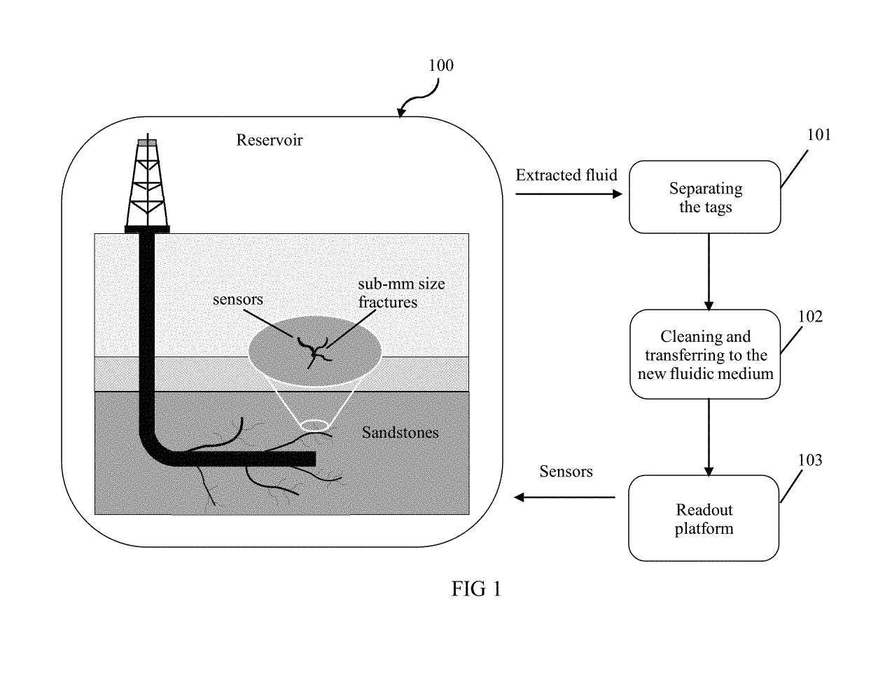

Referring to FIG. 1, as depicted in the illustration 100, embodiments of the present disclosure send small sensors, which may be implemented with various circuitry including wireless (e.g., RFID) tags in a microchip (see FIG. 11), into a downhole and/or reservoir environment (e.g., fractures in an oil-bearing reservoir (e.g., sandstones)) to directly perform the measurements in those locations. For example, within embodiments of the present disclosure, the sensors may be injected into a downhole and/or reservoir environment along with a fluidic medium typically utilized during a hydrocarbon production process (e.g., drilling mud, fracking fluid, etc.), or in any other application where properties of a geological formation need to be measured. The equipment for injecting sensors with such a fluidic medium (e.g., well-known pumping equipment, etc.) is not shown in FIG. 1 for the sake of simplicity.

Then, the sensors are retrieved to the surface, such as within an extracted fluid. For example, within embodiments of the present disclosure, retrieval of the sensors may occur during the extraction of the aforementioned fluidic medium (e.g., drilling mud, fracking fluid, etc.) and/or the production of hydrocarbons (or any other extracted medium, such as water) from the reservoir through a production well. The equipment for extracting such a fluidic medium or a produced medium (e.g., well-known pumping equipment, etc.) is not shown in FIG. 1 for the sake of simplicity.

By filtering the extracted fluid, the sensors may be separated from the extracted fluid in the process block 101. A new fluidic medium can then be used within embodiments of the present disclosure and selected independently from the fluids utilized within the downhole and/or reservoir environment, since the sensors can be filtered after being retrieved to the surface. For example, such a new fluidic medium can be selected to have a much lower salinity than the brine solution utilized within the downhole and/or reservoir environment. Thus, in the process block 102, following an optional cleaning process, the sensors may be placed/inserted into such a new fluidic medium (e.g., different from the extracted fluid and more suitable (e.g., density, viscosity, permittivity) for the functions of communicating with the sensors in a wireless manner) and passed through a readout platform (which may include a reader circuit, such as described herein with respect to FIG. 11) in the process block 103, in which the information stored inside the sensors will be wirelessly retrieved and/or the power sources (e.g., batteries) inside the sensors can be wirelessly recharged. Within some embodiments of the present disclosure, the sensors may then be recycled to be re-injected (delivered) back into the downhole and/or reservoir environment to repeat this work cycle.

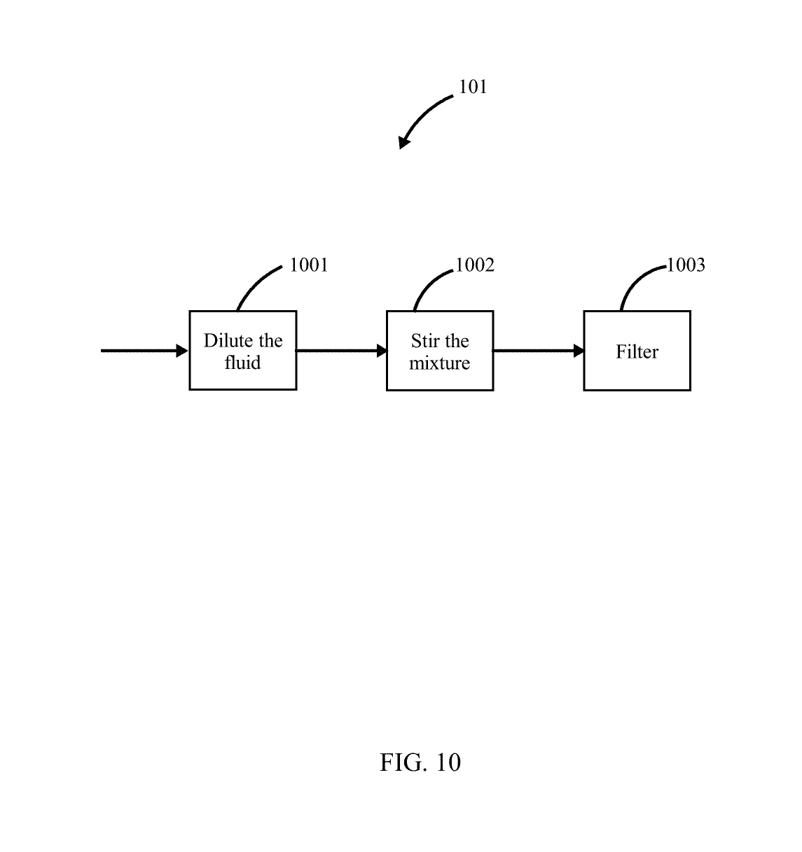

FIG. 10 illustrates an exemplary filtration setup for the process block 101 configured in accordance with embodiments of the present disclosure. In the process block 1001, the extracted fluid may be diluted with water or another desired liquid. Then, in the process block 1002, this mixture may be stirred to separate the sensors apart from the dirt or dust in the extracted fluid. At this stage, the mixture may be scattered into small particles. Then, in the process block 1003, the mixture may be passed through a filter, and only the smaller particles (e.g., smaller than 5 mm) remain, which will include the sensors.

Due to the small sizes and large amount of sensors, a wireless system may be utilized for the information retrieval. A fluidic channel (e.g., a tube) may be utilized for implementing the readout platform to greatly improve the reading efficiency and decrease the operation difficulty, where readout, reprogramming, and/or recharging can be accomplished on-line without need for stopping the flow of sensors in the fluid through the fluidic channel.

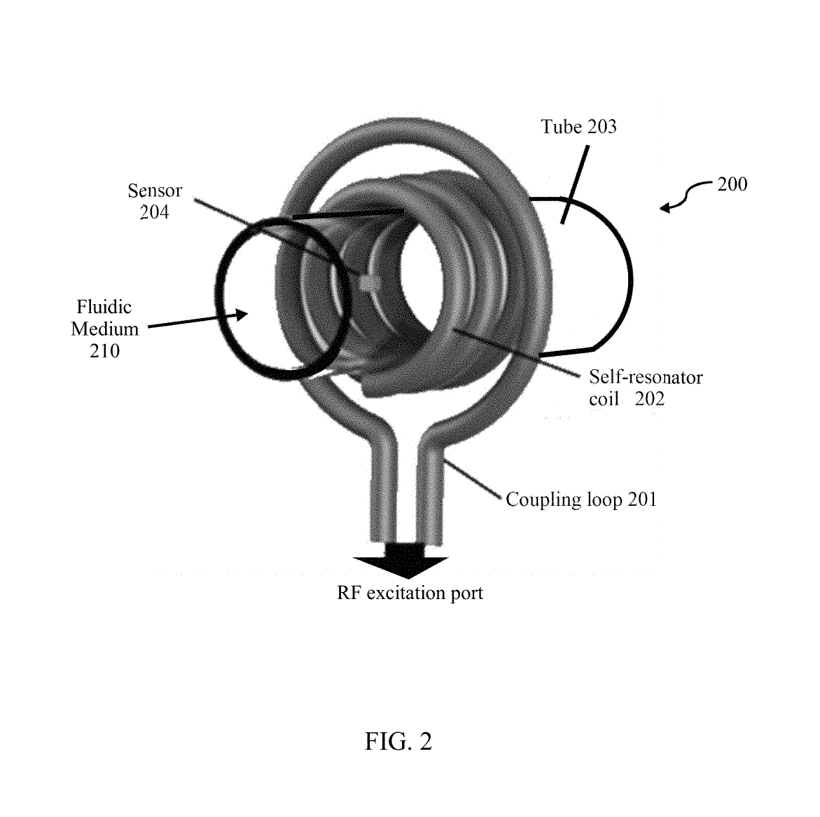

FIG. 2 illustrates embodiments of a readout platform 200 (see the process block 103 of FIG. 1) configured in accordance with certain embodiments of the present disclosure. A coupling loop 201 is activated by a high power RF signal source (FIG. 11) to excite a self-resonator coil 202, which may be configured from a spiral wire wound around a tube 203 (e.g., polycarbonate or any other nonconductive material) to generate a magnetic field, which operates as the communication path for wireless retrieval of the information stored in the sensors 204, and also may be utilized to recharge power sources residing within the sensors 204. Only one sensor 204 is shown for the sake of simplicity. Within embodiments of the present disclosure, such an established communication path may also be utilized to reprogram the sensors, such as to thereafter measure different properties of the downhole and/or reservoir environment during the next work cycle (see discussion of FIG. 1)

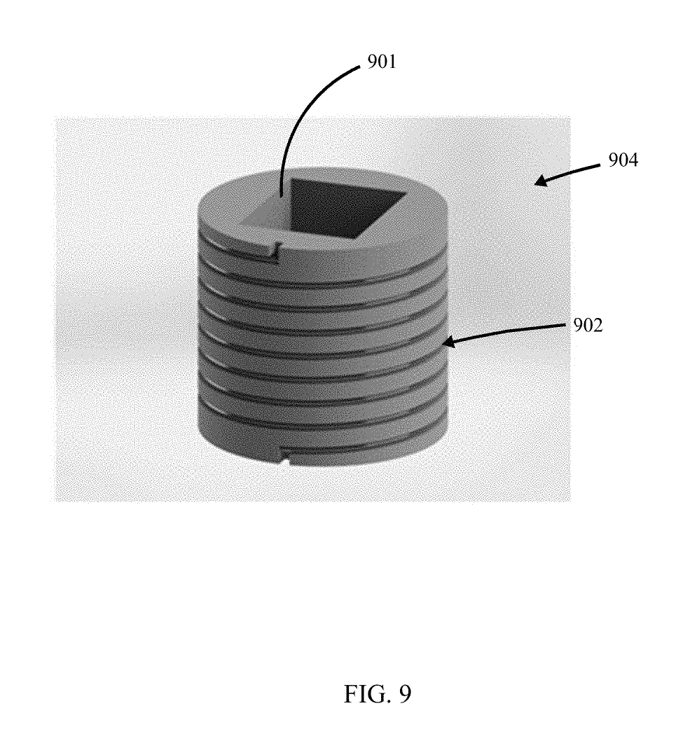

When an RF signal is fed into the coupling loop 201, it inductively excites the self-resonator coil 202 to its self-resonance so that it generates a magnetic field. This magnetic field can be used to charge a power source (e.g., battery) on board the sensor 204, interrogate the sensors 204 so as to retrieve information from the sensors 204, and/or to reprogram the sensors 204 as they pass through the tube 203 in a fluidic medium 210 in proximity to the coupling loop 201 and self-resonator coil 202. Due to the relatively large size of the tube 203 vis-à-vis the sizes of the sensors 204, it is possible to substantially simultaneously manipulate a large number of such sensors 204. The sensors 204 may be packaged (e.g., in the form of a microchip) inside a local field enhancement package as further described with respect to FIG. 9, and flowed through the tube 203.

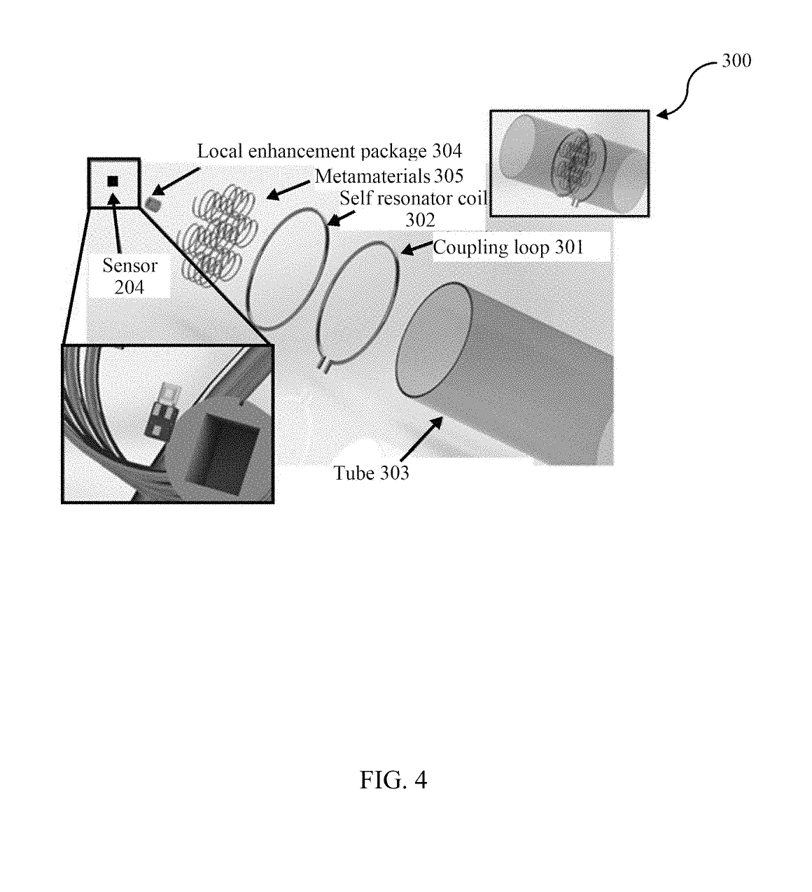

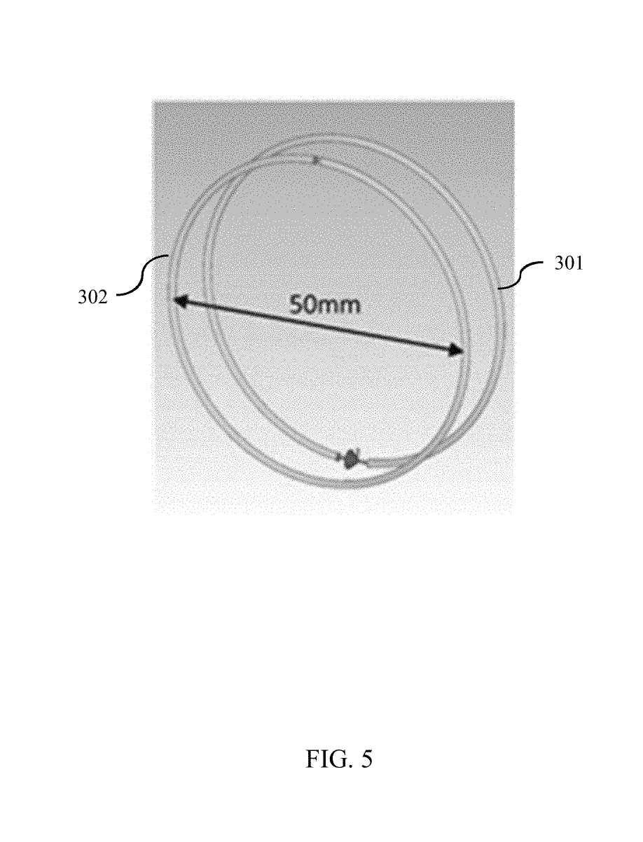

As the diameter of the tube 203 and resultant diameter of the coupling loop 201 increase to cover a larger area (e.g., a larger cross-sectional volume of the tube 203), to keep the resonating frequency the same, the number of turns of the self-resonator coil 202 is decreased. This may result in the self-resonator coil 202 evolving into a split ring 302, which can be treated as a coil with only one turn (e.g., see FIGS. 4 and 5).

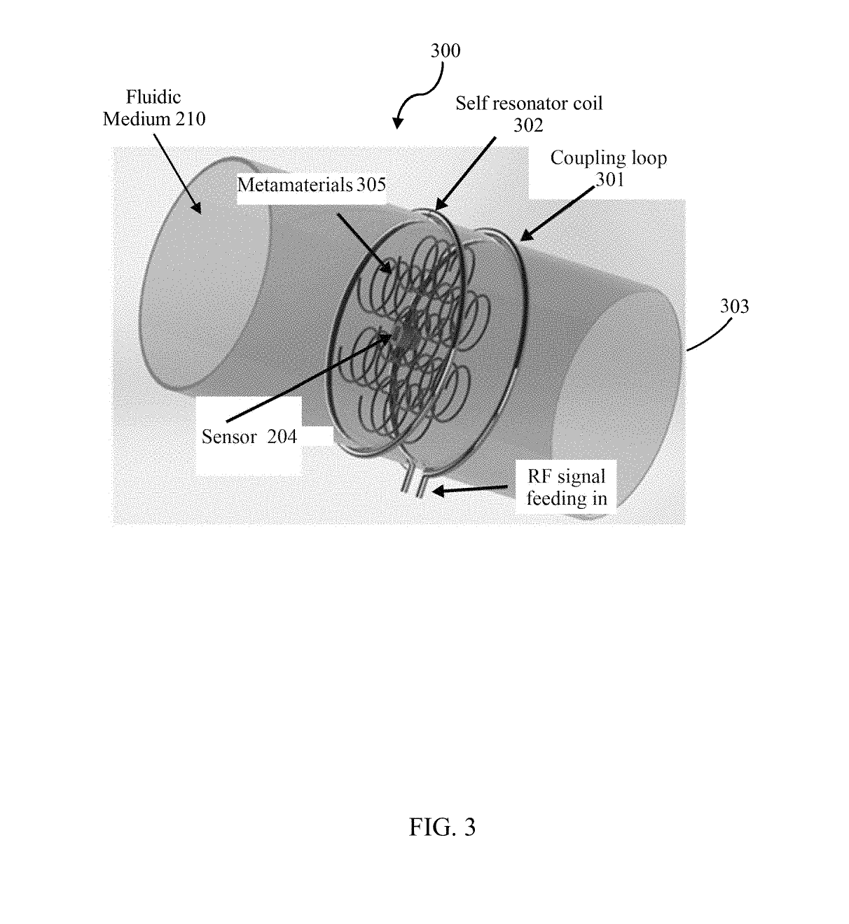

FIG. 3 illustrates embodiments of another readout platform 300 (see the process block 103 of FIG. 1) configured in accordance with embodiments of the present disclosure, which is further shown along with an exploded view of this arrangement in FIG. 4. The sensors 204 (only one sensor 204 is shown for the sake of simplicity) may be packaged (e.g., in the form of a microchip) inside a local field enhancement package (e.g., see FIG. 9), and flowed through a tube 303 (e.g., polycarbonate or any other suitable nonconductive material) as they pass through the tube 203 in a fluidic medium 210 in proximity to the coupling loop 201 and self-resonator coil 202. The coupling loop 201 may be wound outside the tube 303. Inside the tube 303, objects made of metamaterials may be optionally positioned, which may be configured as periodically-patterned spiral coils 305 (also referred to herein as “metamaterial coils”). The tube 303 receives the fluid carrying the sensors 204. The tube may be configured so that the fluid containing the plurality of sensors flows through the metamaterial coils. A RF signal is fed into the coupling loop 301 of the reader antenna, which excites a self-resonator coil 302 to generate an alternating magnetic field. In embodiments of the present disclosure, the self-resonator coil 302 may be configured as a spiral helix shaped wire, or merely a split ring depending upon the resonant frequency of the system.

The coupling loop 301 and the self-resonator coil 302, together, compose a magnetically coupled resonator of the reader antenna (which is also discussed with respect to FIG. 11). The reader antenna (i.e., the coupling loop 301 and the self-resonator coil 302) can have different geometric parameters (e.g., number of turns and spacing between the turns) based on the tubing diameter and designed resonance frequency. The resonating frequency of the reader antenna can be tuned by modifying the number of turns of the self-resonator coil 302, and the impedance of this coupled resonator can be tuned to match the input impedance of the transmission line (e.g., 50 ohms). The alternating magnetic field produced inside the tube 303 may be enhanced by the optionally included metamaterial coils 305, which can be explained by the high equivalent permeability of the metamaterial at the resonating frequency of the coupled resonator.

Microchips implementing the circuitry of the sensors 204 may be packaged inside a local enhancement package, outside of which a self-resonating helix may be patterned to enhance the magnetic field inside the package. A zoomed in image of the microchip and the cavity of the package is shown in FIG. 4 in the left bottom corner.

FIG. 9 illustrates a local field enhancement package 904 configured in accordance with embodiments of the present disclosure. 3D printing may be utilized to fabricate the package 904 with a spiral groove on the outside surface. Thin wires 902 (e.g., with approximately a 25 μm thickness) may be wound around the spiral groove to form a self-resonating helix coil. The microchip implementing the wireless sensor (e.g., see FIG. 4) may be inserted into the cavity 901 of the package and sealed. In embodiments of the present disclosure, the microchip may include a well-known double-layer spiral antenna and a RFID chip (not shown for the sake of simplicity), which may be bonded together (e.g., by a silver epoxy). The magnetic field inside the package 904 is enhanced as a result of the self-resonating helix wire coil 902.

Embodiments of the present disclosure may not need all of the parts shown in FIGS. 3 and 4. Each embodiment can work separately or be combined as needed to achieve a much higher power transfer efficiency. For example, a coupled resonator (e.g., the coupling loop 301 and the secondary coil 302) may be utilized with a local field enhancement package 904 as shown in FIG. 9 to achieve a working distance (e.g., approximately 50 millimeter (“mm”)) for performing the wireless read out of information and/or powering of an onboard power source (e.g., battery). Alternatively, such a coupled resonator may be combined with the metamaterial coils 305, but without utilizing the local field enhancement package 904 for packaging the wireless sensors 204. In an exemplary embodiment, both of these combinations can achieve an approximately 50 mm working distance with an approximately 380×380 square micrometer (“μm²”) sensor antenna, which is further described hereinafter.

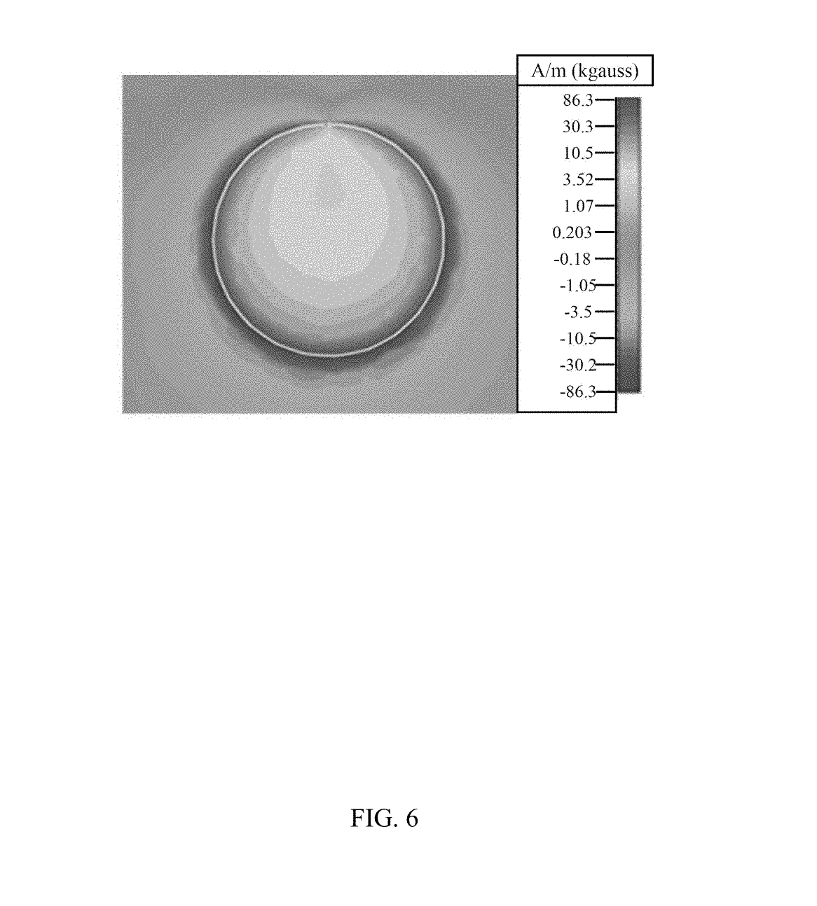

FIGS. 5-8 illustrate how the aforementioned metamaterial design (explained with respect to an exemplary integration of metamaterial coils 305 with a coupling loop 301 and a self-resonator coil 302 configured as split rings) can increase the working distance. FIG. 5 shows a coupled resonator (e.g., a coupling loop 301 and a secondary coil 302) of a reader antenna with a resonant frequency (which may be configured to be approximately 875 MHz). The wireless power transfer efficiency is proportional to the permeability inside the split ring. For naturally available materials, it is usually around 1, or very lossy, at such a high frequency. FIG. 6 shows the magnetic field strength (H-field strength in the z direction (i.e., direction that is perpendicular to this paper)) of such a configuration.

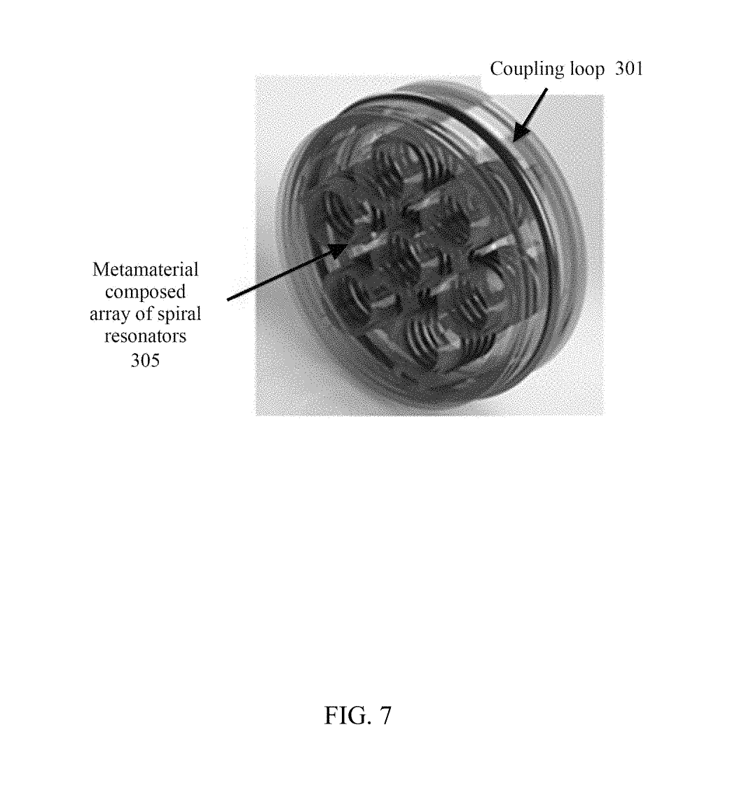

FIG. 7 shows a metamaterial design (similar to that previously described with respect to FIGS. 3 and 4) configured to boost a uniform magnetic field over the cross-section of the tube 303. As previously described, the coupling loop 301 is used to generate the magnetic field inside of the tube 303. The metamaterial positioned inside the tube 303 in proximity to the coupling loop 301 may compose an array of spiral resonators each made of the metamaterial. By carefully designing the electromagnetic property of each spiral loop and their layout together, the working frequency of the metamaterial can be tuned to the desired frequency point. Thus, the metamaterial coils 305 may be configured to boost the permeability inside the ring at the working frequency to dramatically enhance the magnetic flux, so that the power transfer efficiency and working distance is increased.

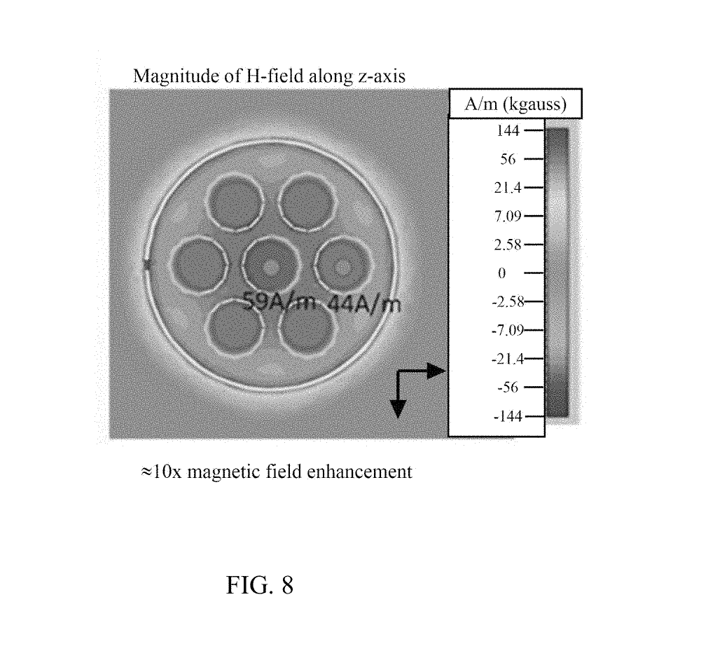

FIG. 8 shows the magnetic field strength (H-field strength in the z direction (i.e., direction that is perpendicular to this paper)) of a such reader antenna configured with such a metamaterial design. Note that a comparison between FIGS. 6 and 8 shows that the field strength of the configuration in FIG. 7 (i.e., which includes the metamaterial coils 305) is about 10 times more than the configuration in FIG. 5 (i.e., which does not include the metamaterial coils 305).

FIG. 11 illustrates a block diagram of exemplary reader and sensor circuits, which may be utilized within embodiments of the present disclosure. The reader circuit 1101 may be associated with the readout platform previously described with respect to FIG. 1. The reader antenna 1105 may be configured as the coupling loop 201 previously described with respect to FIG. 2, or the coupling loop 301 and self-resonator coil 302 previously described with respect to FIGS. 3 and 4. The sensor circuit 1102 may be implemented within a sensor 204.

Within the reader circuit 1101, a voltage controlled oscillator (“VCO”) 1103 may be used to generate a radio frequency (“RF”) signal. The RF signal may be amplified by a RF power amplifier 1104 and then fed to the reader antenna 1105. Through magneto-resonant coupling between the reader antenna 1105 and the sensor antenna 1106, the RF signal is thus coupled to the sensor circuit 1102 within each of the sensors 204. A rectifier 1107 on the sensor circuit 1102 may be utilized to convert the input RF signal to direct current (“DC”) voltage. The DC voltage can be fed to a voltage regulator 1108 (and accompanying power source (e.g., a battery)) to generate a stable voltage supply to the microcontroller unit (“MCU”) 1109 and other components of the circuit 1102. The MCU may have an electronic storage device (memory) associated therewith for storage of the information measured by one or more sensor circuit(s) 1114 implemented within each of the sensors 204, which are configured to sense a particular property of the downhole and/or reservoir environment. The MCU 1109 can be programmed to realize different functions, such as interacting with the one or more sensor circuits 1114. One of the output pins may be connected with a modulator 1110 to modulate the impedance of the sensor antenna 1106 according to the information needed to be sent to generate a backscattering signal. The backscattering signal may be collected by the reader antenna 1105 and demodulated by a demodulator 1111 to recover the sent information (e.g., the demodulated signal 1112, which can then be output to other suitable equipment, such as a computer, utilized to collect and analyze the retrieved information). Amplitude shift keying (“ASK”) may be used in the communication because of its simplicity in both modulation and demodulation circuitry. With such a design, the sensor circuit 1102 can be wirelessly powered (e.g., utilizing the power supply 1113), and the function(s) of the sensor circuit 1102 programmable with the MCU 1109. In certain embodiments of the present disclosure, the sensor circuit 1102 may be wirelessly powered and, therefore, does not require a battery or other type of power source.

Within embodiments of the present disclosure, since the interaction of time between the sensor and readout antennas may be limited as a result of the rate of flow of the fluidic medium within which the sensors are injected for passing through the system at the surface, several such readout antenna configurations (e.g., see FIGS. 2-4) may be placed along the piping (e.g., tubes 203, 303) (see the process block 103 of FIG. 1) utilized for reading of the information from the sensors 204 and/or so that a more complete recharging of the sensors 204 (which may include batteries or other power sources) can be accomplished as needed.

As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D.

It will be understood that particular embodiments described herein are shown by way of illustration and not as limitations of the invention. The principal features of this invention can be employed in various embodiments without departing from the scope of the invention.

Unless defined otherwise, all technical and scientific terms used herein have the same meaning as commonly understood to one of ordinary skill in the art to which the presently disclosed subject matter belongs. Following long-standing patent law convention, the terms “a” and “an” mean “one or more” when used in this application, including the claims.

What is claimed is:

1. A system for reading information from sensors carried in a fluidic medium, comprising:
equipment for extracting a fluid from a geological formation, wherein the fluid contains a plurality of sensors that have information stored in an electronic storage device implemented within each of the plurality of sensors;
equipment for transferring the extracted fluid through a fluidic channel;
a self-resonator comprising a wire wound around the fluidic channel;
a coupling loop positioned in proximity to the self-resonator;
a RF signal source coupled to the coupling loop, whereby the RF signal source is configured to feed a RF signal into the coupling loop, wherein the coupling loop and the self-resonator are configured so that the coupling loop inductively excites the self-resonator to its self-resonance to generate a magnetic field suitable to retrieve the information from each of the plurality of sensors as they pass in proximity to the coupling loop.

2. The system as recited in claim 1, wherein the fluidic channel comprises tube made of a nonconductive material.

3. The system as recited in claim 1, wherein the wire of the self-resonator is spirally wound around the fluidic channel with a number of turns suitable to achieve the magnetic field that is suitable to retrieve the information from each of the plurality of sensors.

4. The system as recited in claim 3, wherein the wire is configured as a split ring.

5. The system as recited in claim 1, wherein the self-resonator and the coupling loop are configured so that the coupling loop inductively excites the self-resonator so that it is suitable to charge a battery implemented within each of the plurality of sensors as they pass in proximity to the coupling loop.

6. The system as recited in claim 1, further comprising equipment configured to inject the plurality of sensors back into the geological formation.

7. The system as recited in claim 1, wherein each of the plurality of sensors comprises:
a local field enhancement package;
a sensor circuit embedded within the local field enhancement package; and
a magnetically coupled self-resonating coil wound around an outside of the local field enhancement package.

8. The system as recited in claim 1, further comprising a secondary coil wound around the fluidic channel in proximity to the self-resonator, wherein the secondary coil and the self-resonator are configured to produce an alternating magnetic field inside of the fluidic channel as a result of excitation by the RF signal.

9. The system as recited in claim 1, further comprising one or more metamaterial coils positioned in the fluidic channel in proximity to the coupling loop.

10. The system as recited in claim 1, wherein the fluidic channel is configured so that the fluid containing the plurality of sensors flows through the metamaterial coils.

11. A system for reading information from sensors carried in a fluidic medium comprising:
a self-resonator comprising a wire wound around the fluidic channel;
a coupling loop positioned in proximity to the self-resonator;
a RF signal source coupled to the coupling loop, whereby the RF signal source is configured to feed a RF signal into the coupling loop, wherein the coupling loop and the self-resonator are configured so that the coupling loop inductively excites the self-resonator to its self-resonance to generate a magnetic field suitable to retrieve the information from each of the plurality of sensors as they pass in proximity to the coupling loop.

12. The system as recited in claim 11, wherein the fluidic channel comprises a nonconductive material.

13. The system as recited in claim 11, wherein the wire of the self-resonator is spirally wound around the fluidic channel with a number of turns suitable to achieve the magnetic field that is suitable to retrieve the information from each of the plurality of sensors.

14. The system as recited in claim 11, wherein the wire is configured as a split ring.

15. The system as recited in claim 11, wherein the self-resonator and the coupling loop are configured so that the coupling loop inductively excites the self-resonator so that it is suitable to change a battery implemented within each of the plurality of sensors as they pass in proximity to the self-resonator.

16. The system as recited in claim 11, wherein each of the plurality of sensors comprises:
a local field enhancement package;
a sensor circuit embedded within the local field enhancement package; and
a magnetically coupled helix coil wound around an outside of the local field enhancement package.

17. The system as recited in claim 11, further comprising a secondary coil wound around the fluidic channel in proximity to the self-resonator, wherein the secondary coil and the self-resonator are configured to produce an alternating magnetic field inside of the fluidic channel as a result of excitation by the RF signal.

18. The system as recited in claim 11, further comprising one or more metamaterial coils positioned in the fluidic channel in proximity to the coupling loop.

19. The system as recited in claim 11, further comprising one or more metamaterial coils positioned in the fluidic channel in proximity to the self-resonator.

20. The system as recited in claim 18, wherein the fluidic channel is configured so that the fluid containing the plurality of sensors flows through the one or more metamaterial coils.
